(19) United States
(12) Patent Application Publication
(10) Pub. No.: US 2022/0366642 A1
(43) Pub. Date: Nov. 17, 2022

(54) GENERATION OF OBJECT ANNOTATIONS ON 2D IMAGES

(71) Applicant: Baker Hughes Holdings LLC, Houston, TX (US)

(72) Inventors: Vladimir Shapiro, Newton, MA (US); Ozge Can Whiting, Niskayuna, NY (US); Taufiq Dhanani, San Ramon, CA (US); John Hare, Highland, NY (US); Matthias Odisio, Dallas, TX (US); Edvardas Kairiukstis, Boston, MA (US)

(21) Appl. No.: 17/739,842

(22) Filed: May 9, 2022

Related U.S. Application Data
(60) Provisional application No. 63/186,944, filed on May 11, 2021.

(51) Int. Cl. G06T 15/20; G06T 7/11; G06F 40/169; G06T 11/60

(52) U.S. Cl. CPC G06T 15/205; G06T 7/11; G06F 40/169; G06T 11/60; G06T 2219/004

(57) ABSTRACT

A method includes receiving data characterizing a two-dimensional target site image including an image of a first asset acquired by a camera. The camera has a first location during the acquisition of the two-dimensional target site image. The method also includes receiving data characterizing a three-dimensional model of a target site that includes a plurality of assets including the first asset. The three-dimensional model is annotated to at least identify the first asset. The method further includes generating a projected annotation of the first asset on the two-dimensional target site image by at least projecting the three-dimensional model based on the first location and orientation of the camera relative to the first asset during the acquisition of the target site image.

### RELATED APPLICATION

This application claims priority under 35 U.S.C. § 119(e) to U.S. Provisional Patent Application No. 63/186,944 filed on May 11, 2021, the entire content of which is hereby expressly incorporated by reference herein.

### BACKGROUND

Industrial operations can include monitoring, maintaining and inspecting assets for anomalies, defects, emissions and other events in an industrial site. As an example, a drone or a satellite comprising a camera can fly over the industrial site and capture images of the industrial site. Based on these images the assets in the industrial sites can be monitored

### SUMMARY

In one implementation, the method includes receiving data characterizing a two-dimensional target site image including an image of a first asset acquired by a camera. The camera has a first location during the acquisition of the two-dimensional target site image. The method also includes receiving data characterizing a three-dimensional model of a target site that includes a plurality of assets including the first asset. The three-dimensional model is annotated to at least identify the first asset. The method further includes generating a projected annotation of the first asset on the two-dimensional target site image by at least projecting the three-dimensional model based on the first location and orientation of the camera relative to the first asset during the acquisition of the target site image.

One or more of the following features can be included in any feasible combination.

In some implementations, the method includes receiving data characterizing a plurality of two-dimensional images of the target site acquired at a plurality of locations. Each image of the plurality of two-dimensional images is acquired at a unique location of the plurality of locations and with a unique camera orientation of the plurality of orientations. The method also includes generating the three-dimensional model of the target site based on the plurality of two-dimensional images. The method also includes receiving data characterizing the identity of one or more of the plurality of assets in the target site. The method further includes annotating the three-dimensional model of the industrial asset to identify at least the first asset of the plurality assets.

In some implementations, the method further includes providing, via a graphical user interface, the three-dimensional model of the target site to a user. The method also includes receiving user input indicative of data characterizing identity of a first asset of the plurality of assets in the target site. The method further includes annotating at least a first portion of the three-dimensional model indicative of the first asset based on the received user input.

In some implementations, the method further includes receiving data characterizing the plurality locations associated with the acquisition of the plurality of two-dimensional images. In some implementations, the plurality of locations are detected by one of a position sensor and a global positional system tag coupled to the camera or to a drone to which the camera is attached. In some implementations, the camera is coupled to one of a drone and a satellite configured to inspect the target site.

In some implementations, the annotation of the first asset includes determining a first contour associated with the first asset. In some implementations, determining the first contour includes determining that a first distance between the first asset and the camera is greater than a second distance between a second asset and the camera, where in the first asset and the second asset are located adjacent to each other. Determining the first contour further includes identifying a first portion of the first contour that overlaps with the second asset; and annotating the first asset to preclude portions of the first asset located between the first portion of the first contour and a second contour of the second asset.

In some implementations, the method further includes determining that a first distance between a first portion of the first asset and the camera is greater than a second distance between a second portion of a second asset and the camera. The method also includes identifying that the first portion of the first asset overlaps with the second portion of the second asset from the perspective of the camera during the acquisition of the two-dimensional target site image. The method further includes annotating the first asset to preclude the first portion of the first asset.

In one implementation, a method includes receiving one or more two-dimensional (2D) baseline images of a target site that includes one or more assets. The method also includes generating a 3D model of the target site based on the received 2D images. The method further includes identifying at least a portion of the assets on the 3D model. The method also includes receiving a target site image (e.g., from a camera configured to inspect the target site), and annotating the received target site image based on a 2D projection of the 3D model (e.g., along camera direction associated with the received target site image) that may account for occlusion of one or more features in the target site image.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

These and other capabilities of the disclosed subject matter will be more fully understood after a review of the following figures, detailed description, and claims.

### DESCRIPTION OF DRAWINGS

These and other features will be more readily understood from the following detailed description taken in conjunction with the accompanying drawings, in which:

FIG. 1 is a flow diagram illustrating one embodiment of a method for annotating a target site image;

FIG. 2A is a two-dimensional image of a target site containing assets to be monitored;

FIG. 2B is another two-dimensional image of a target site including overlaid asset contours;

FIG. 3 illustrates a camera configured to capture a target site image;

FIG. 4A illustrates an exemplary target site image that does not account for occlusion;

FIG. 4B illustrates an exemplary target site image that accounts for occlusion;

FIG. 5 is a flow diagram illustrating another embodiment of a method for annotating a target site image; and

FIG. 6 depicts a block diagram illustrating an example of a computing system, in accordance with some example embodiments.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Machine learning algorithms (e.g., supervised Machine learning) can be used for recognition of object images. For example, the object image can be a two-dimensional (2D) image (e.g., RGB image, IR image, etc.). The machine learning algorithm may need to be trained on annotated training images. Training images can be annotated manually. For example, human operators can sift through a large number of training images and manually annotate object images in the training images (e.g., by creating a bounding polygon to indicate the object image location in a training image). The complexity of manual annotation can increase as the number of object images and/or number of appearance of an object image increase in the training images. Systems and methods described in the current subject matter can reduce human interaction when annotating 2D images of a target site. The annotated 2D image can be used for training machine learning algorithm that can detect and recognize images of the target site. However, it can be understood that embodiments of the disclosure can be employed for annotating any 2D image without limit.

A three-dimensional (3D) model of a target site can be constructed photogrammetrically (e.g., from individual images of the target site captured by an image sensor or a camera), or with 3D laser scanning. Various objects (or assets) in the target site can be labelled/annotated by human operators (e.g., by selecting points belonging to the objects/assets). 3D segmentation techniques can be used to detect automatically target objects from a target site image using a 3D model of the target site and label points/surfaces that belong to the target object with the ID of the target object in the target site image. This can be done, for example, by projecting the 3D model of the target site (along with relevant annotation and geometry information) onto a 2D image and comparing the projected image with the target site image.

Assets in an industrial site can be monitored by using AI/Machine Learning (ML)/automation. AI/Machine Learning automation can include training Machine Learning (ML) methods or models in order to enable these methods or models to automatically identify/locate the assets of interest on two-dimensional images of an industrial site captured from a drone or a satellite. An ML method can use a large number of two-dimensional images on which the assets of interest are “annotated.” Annotation of the asset can include outlining the asset by a contour, representing the asset by a mask, etc. Annotations of the asset can include adding a label or an instance number to the assets (e.g., multiple assets of the same type on a given site can be labelled as. “oil tank 1”, “oil tank 2”, etc.).

Traditional way of creating annotations on images requires a large amount of work by human annotators through one or more of manual drawing, painting an outline, adding a mask on each image out of multitude of images needed for training an accurate ML method or model. Some implementations of systems and methods described below includes creating a single three-dimensional annotation on a three-dimensional model (e.g., this can be done manually or automatically using methods outside of the scope). This three-dimensional model can be referred to as a “digital twin”. Such three-dimensional annotation on a three-dimensional model is created once and there are physical changes that affect the asset integrity. After three-dimensional annotations for the assets are created, the methods below allows generation of two-dimensional annotations on a multitude of two-dimensional images with no additional human interaction.

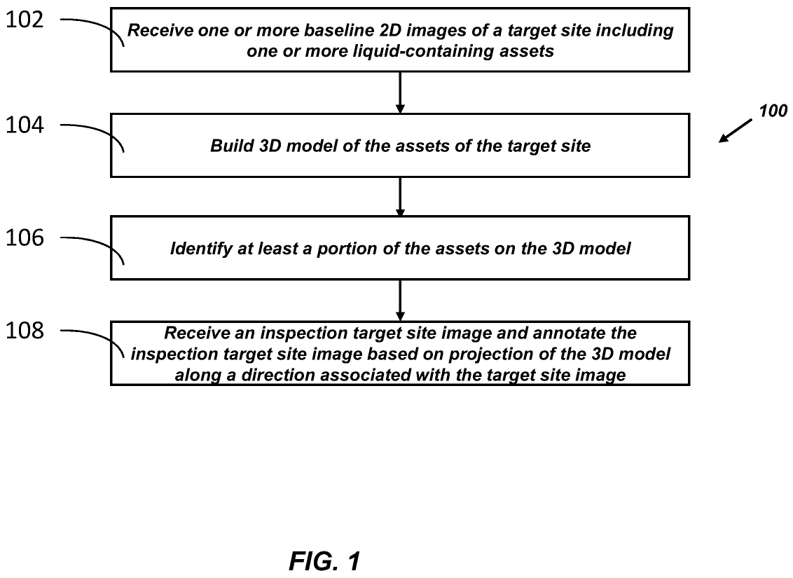

FIG. 1 is a flow diagram illustrating one embodiment of a method 100 for annotating 2D images using a 3D model of a target site (e.g., 3D model of a site that includes the assets depicted in the 2D image). As shown, the method 100 includes operations 102-108. However, it can be understood that, in alternative embodiments, one or more of these operations can be omitted and/or performed in a different order than illustrated.

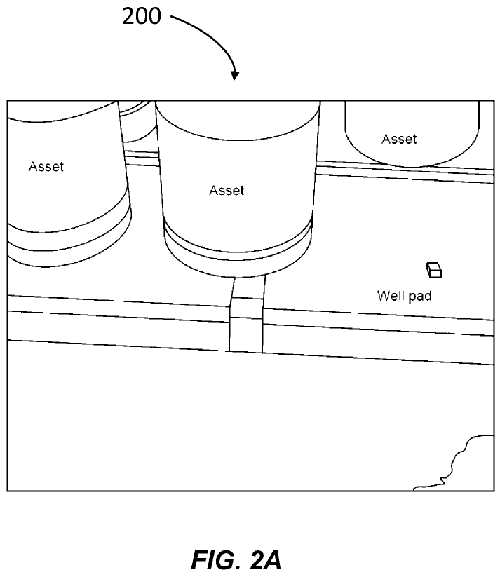

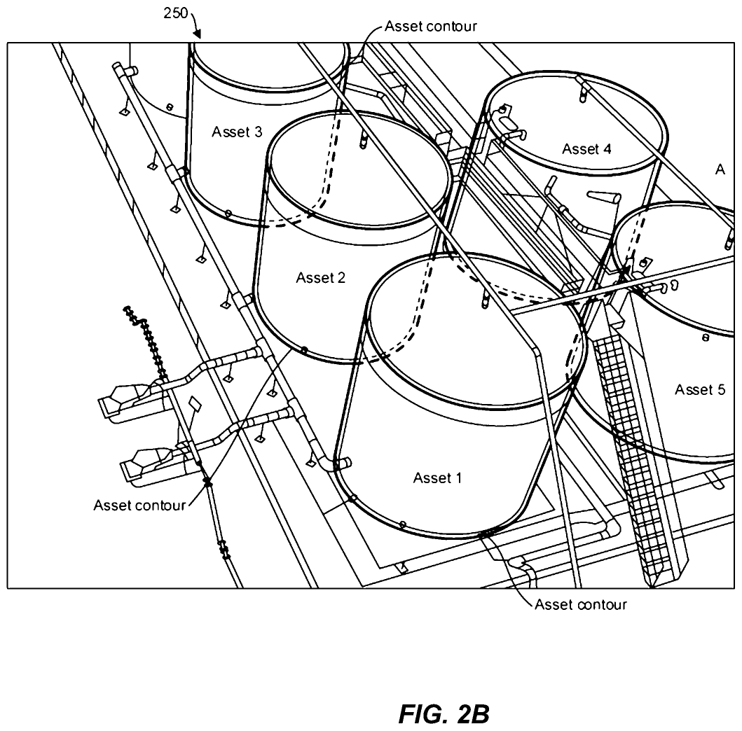

In operation 102, one or more 2D images or 3D laser scans of the target site including one or more assets can be received (e.g., by a computing device of a 3D reconstruction system). The 2D images, also referred to as baseline images herein, can be acquired in a variety of ways. In one embodiment, the baseline 2D images can be acquired by at least one image sensor (“camera”) mounted to an aerial vehicle (e.g., a manned airplane, a helicopter, a drone, or other unmanned aerial vehicle). The image sensor can be configured to acquire infrared images, visible images (e.g., grayscale, color, etc.), or combination thereof. The image sensor can also be in communication with a position sensor (e.g., a GPS device) configured to output a position, allowing the first 2D images to be correlated with the position at which they are acquired. FIG. 2A illustrates an exemplary 2D image 200 (or a baseline image). The 2D image 200 includes images of multiple assets (e.g., vessels, well pads, etc.).

In operation 104, the baseline 2D images and position information can be analyzed to generate a 3D model of the target site (e.g., well pad). In some implementations, a portion of the target site can be detected based on triangulation of one or more of the baseline 2D images. A point (or a pixel) of a baseline 2D image can be identified that corresponds to the portion of the target site (e.g., a line exists in the three dimensional space that can intersect with the portion of the target site image and the pixel in the baseline 2D image. This process can be repeated for multiple baseline 2D images (e.g., at least two baseline 2D images). Based on the location of the camera capturing the baseline 2D images and the location of the identified pixels in the corresponding location, a depth associated with the portion of the target site image can be determined. 3D model of the target site can be generated by repeating this process for multiple portions of the target site.

In operation 106, at least a portion of the assets (e.g., vessels) can be identified on the 3D model. In one example, 3D primitives can be fit to the 3D point cloud. In another example, an annotation technique can be employed. In some implementations, steps 102-106 (referred to as “onboarding”) can be performed once and data associated with these steps (e.g., 3D model, primitives, annotation information, etc.) can be stored.

In operation 108, an image of a target object (e.g., an asset in the target site) can be annotated in a target site image. The target site image can be generated, for example, by a camera coupled to a drone, or to a satellite, configured to inspect the target site. In some implementations, the image of the target object can be identified from the image of the target site (e.g., prior to annotation). This can be done by determining the location of the camera relative to the target site when the target site image is captured. The location can be determined, for example, by a position sensor/global positional system (GPS) tag coupled to the camera and/or the drone. Once the relative position/orientation of the camera is determined, the 3D model of the target site (e.g., generated in operation 104) can be projected along the direction of camera relative to the target site. The projected image can be compared with the target site image, and based on this comparison one or more assets of the target site image (e.g., image of the target object) can be identified and annotated on the target site image.

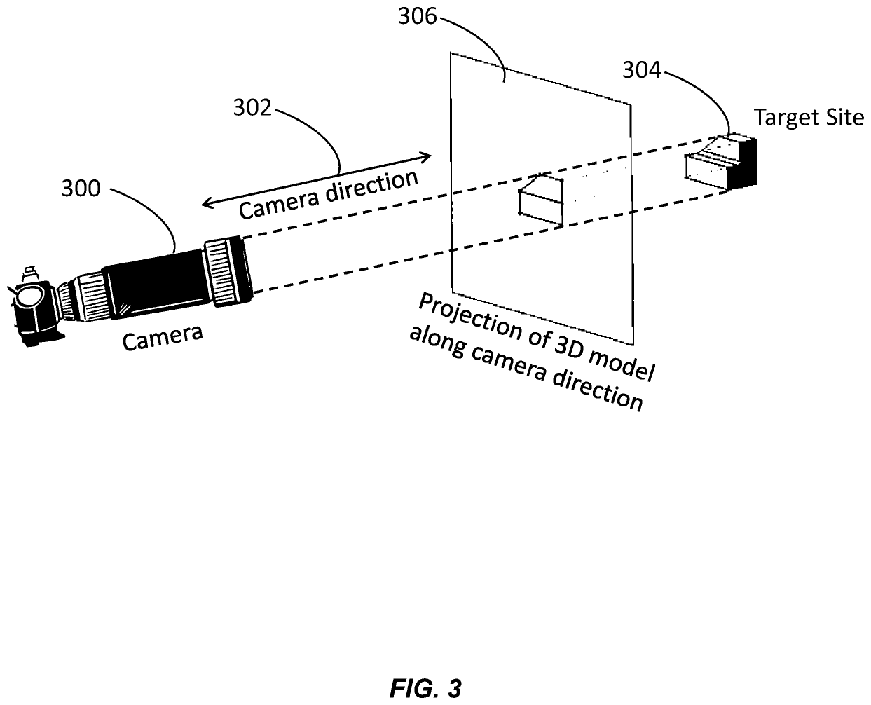

FIG. 3 illustrates a camera 300 oriented along the camera direction 302 relative to an exemplary target site 304 (or a portion thereof). Based on the orientation/position of the camera 300 relative to the target site, the 3D model of the target site 304 can be projected along the camera direction to generate a 2D image 306. The projected 2D image 306 can be compared with the target site image captured by the camera 300. Based on this comparison, assets on the target site image can be identified. Movement of the camera 300 to a second location will result in a second camera direction and a second projected 2D image. The second projected 2D image can then be compared to the target site image obtained by the camera 300 from the second location.

Identification of assets on the target site image can include determining contours surrounding one or more assets (e.g., contours around the target object). FIG. 2B illustrates an exemplary 2D target site image 250 that includes asset contours overlaid on the target site image. The 3D model can include information associated with the contours with the various assets in the target site. When the 3D model is projected onto a 2D image, the contour information can be included in the projected 2D image. By annotating the target image by comparing the projected 2D image with the target image, contours of the assets in the target image can be identified. However, in some cases, the identified contour around a target object may not be accurate (e.g., contour of one asset may overlap with another asset). As illustrated in FIG. 2B, contour of Asset 2 (marked in red) overlaps with Asset 1. In other words, Asset 2, which is located behind Asset 1 (from the perspective of the camera 300 along camera direction), is partially hidden (“occluded”) by Asset 1. Therefore, simply adding the contour of Asset 2 (which may be of a predetermined shape) onto the image of Asset 2 may overlap with Asset 1. As a result, contours of Asset 2 in the image 2B may not be accurately determined. This can result in annotation errors in the test site image which in turn can lead to errors in training algorithms that use the test site image for training.

In some implementations, errors in the identification of contours of the assets in the target site image (due to occlusion) can be improved based on determination the order in which two or more assets are located relative to the camera (or depth of the assets relative to the camera) capturing the target site image. For a pair of assets in the target site image that have overlapping contours, the asset closer to the camera (which acquired the target site image) can be determined. For example, it can be determined that a first asset is closer to the camera than a second asset during the acquisition of target site image. In other words, the second asset is behind the first asset from the point of view of the camera. In this case, portions of the contours of the second asset that overlap with the first asset can be removed from the target site image.

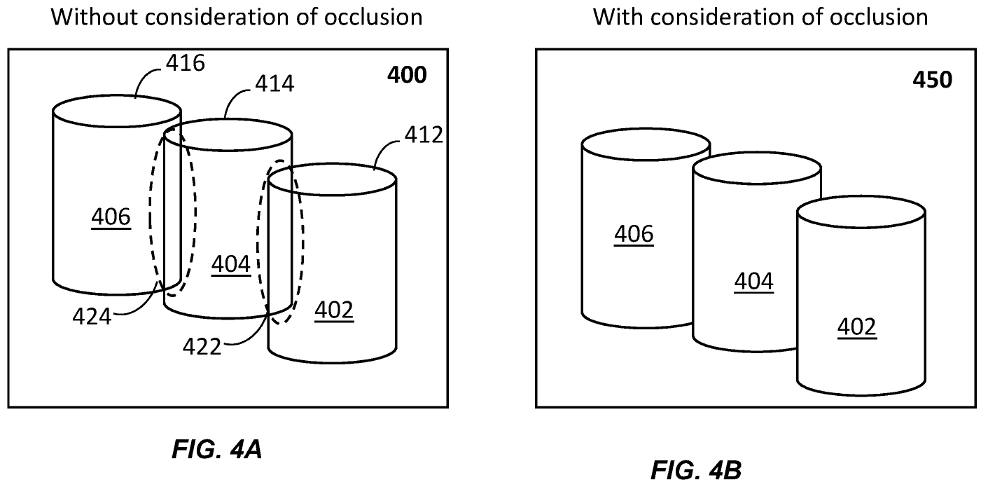

FIG. 4A illustrates an exemplary target site image 400 that does not account for occlusion. The target site image 400 includes a first asset 402, a second asset 404 and a third asset 406. In this example, the first asset 402 is closest to the camera and the third asset is furthest away from the camera. The target site image 400 does not account for occlusion as the the contours of the three assets overlap. For example, a first contour 412 of the first asset 402 overlaps with a second contour 414 of the second asset 404; and the second contour 414 overlaps with a third contour 416 of the third asset 416.

FIG. 4B illustrates an exemplary target site image 450 that accounts for occlusion. For example, since the first asset 402 is closer to the camera than the second asset 404, a portion of the second contour of the second asset 404 that overlaps with the first asset 402 is identified and removed. Portion (indicated by region 422) of the second asset 404 located between the first contour 412 and the aforementioned portion of the second contour is precluded from the annotation of the second object 404. Since the second asset 404 is closer to the camera than the third asset 406, a portion of the third contour 416 that overlaps with the second asset 404 is identified and removed. Portions of the third asset 406 located between the second contour 414 and the aforementioned portion of the third contour (indicated by region 424) is precluded from the annotation of the third object 406.

In some implementations, if a first portion of a first asset (e.g., first asset 402) is closer to the camera than a second portion of a second asset (e.g. second asset 404) and the second portion of the second asset overlaps with the first portion of the first asset (e.g., from the viewpoint of the camera), the second portion of the second asset is not annotated (or precluded from annotation). For example, the second portion of the second asset will not be annotated as the second asset.

It can be desirable to determine the contours of assets that have been occluded in the test site image accurately. In some implementations, determination of asset contours can be improved by accounting for the relative distance (or “depth”) between the camera and the assets in the target site image (e.g., along the camera direction). In some implementation, the depth of the assets can be determined from the 2D projection of the 3D model along the camera direction. The 2D projection (“depth map”) can include the depth information (e.g., for each pixel in the 2D projection). A sudden change in the depth values of a first pixel and a second pixel located close to the first pixel can indicate that the first and the second pixels are indicative of different assets in the target site image. Based on this determination, the contours of the different assets can be modified to account for occlusion (e.g., keep the contours of the asset with lower depth value unchanged and change the contours of the asset with higher depth value). The 2D projection of the 3D model can be repeated for various camera directions. Additionally, the annotation information can be transferred from the 3D model to the 2D projection of the 3D model.

In some implementations, assets annotated in the 3D model may be used to parse the scene for each 2D image. Depth of an asset can be calculated as an averaged depth (e.g., Euclidean distance from each 3D annotation point to the camera) of each asset centroid. A given reference asset can be analyzed against other assets in the target asset image, and assets located closer to the camera can be identified and their spatial occlusion with the target object can be determined. In some implementations, if the spatial occlusion between an asset and the target object (e.g., fraction of the target object intersected by the asset) is above a threshold value, no annotation is generated.

In some implementations, the shape of assets in the 3D model (or a portion thereof) after projection on a 2D image can be known in advance (e.g. planar line, circle, polygon, etc.). This can reduce the number of pixels that need to be annotated (e.g., two points for a straight line, etc.). More points for higher fidelity can be generated automatically after fitting the line to the two points. Similar approach can be applied to other 2D curves and 3D primitives like cylinders, polyhedrons, etc. Data augmentation helps generating extra points without human involvement.

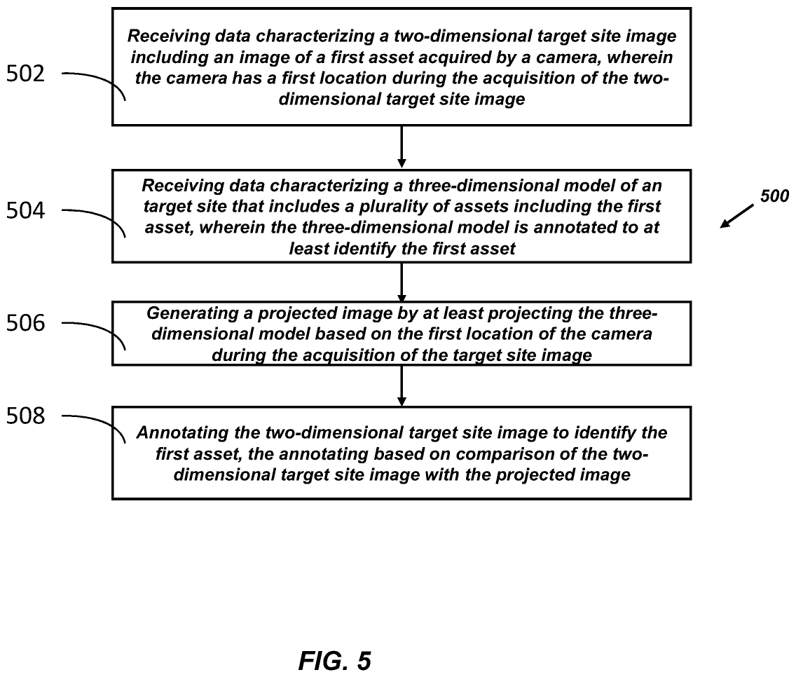

FIG. 5 is a flow diagram illustrating another embodiment of a method 500 for annotating 2D images. At step 502, data characterizing a two-dimensional target site image including a first asset is received (e.g., by a computing device). The 2D target site image is acquired by a camera located at a first location/first orientation. In some implementations, a position sensor or a global positioning system (GPS) tag can be coupled to the camera that can detect/measure the location (e.g., first location of the camera when the target site image of the first asset is acquired) of the camera when images of the target site (which includes the first asset) are acquired. In some implementations, data characterizing the locations of the camera (e.g., first location) can be received (e.g., by the computing device).

At step 504, data characterizing a three-dimensional model of a target site can be received. The three-dimensional model is indicative of a plurality of assets in the target site (e.g., the first asset). In some implementations, the three-dimensional model of the target site can be generated. The three-dimensional model generation can include receiving data characterizing a plurality of two-dimensional images of the target site acquired by a camera. The camera can move (e.g., can be attached to a drone) and acquire the images from multiple locations. For example, each image of the plurality of two-dimensional images can be acquired from a unique location of the camera. The three-dimensional model of the target site can be generated based on the plurality of two-dimensional image (e.g., as described in operation 104 above). The three-dimensional model can be annotated to identify one or more assets in the target site (e.g., at least identify the first asset). In some implementations, the three-dimensional model can be presented to a user via a graphical user interface. The user can annotate the three-dimensional model. For example, the user can select an asset (e.g., first asset) in the three-dimensional model and provide information associated with the asset (e.g., identity of the asset).

At step 506, a projected image is generated by projecting the three-dimensional model along the camera direction (e.g., direction of the camera based on the first location of the camera during the acquisition of the target site image). For example, as illustrated in FIG. 3, the three dimensional model of the target site can be projected along the camera direction 302 (e.g., which can be determined based on the first position and orientation of the camera during the acquisition of the first image).

At step 508, the two-dimensional target site image (e.g., received at step 502) is annotated to identify the first asset. The annotation can be based on comparison of the two-dimensional target site image with the projected image. As discussed above, identification of the first asset can include determining contours of one or more assets (e.g., first image) in the two-dimensional target site image.

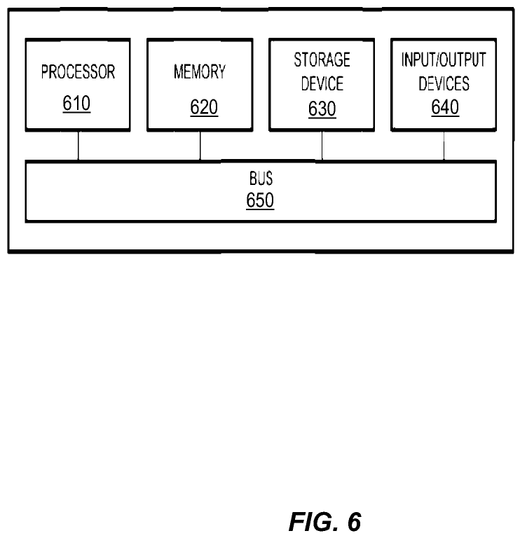

FIG. 6 illustrates an exemplary computing system 600 configured to execute the data flow described in FIG. 1, FIG. 5, etc. The computing system 600 can include a processor 610, a memory 620, a storage device 630, and input/output devices 640. The processor 610, the memory 620, the storage device 630, and the input/output devices 640 can be interconnected via a system bus 650. The processor 610 is capable of processing instructions for execution within the computing system 600. Such executed instructions can implement one or more steps described in FIG. 1, FIG. 4, etc. In some example embodiments, the processor 610 can be a single-threaded processor. Alternately, the processor 610 can be a multi-threaded processor. The processor 610 is capable of processing instructions stored in the memory 620 and/or on the storage device 630.

The memory 620 is a computer readable medium such as volatile or non-volatile that stores information within the computing system 600. The memory 620 can store, for example, the two-dimensional target site image, the three-dimensional model, projected image, annotated two-dimensional target site image, etc. The storage device 630 is capable of providing persistent storage for the computing system 600. The storage device 630 can be a cloud-based storage system, floppy disk device, a hard disk device, an optical disk device, a tape device, a solid state drive, and/or other suitable persistent storage means. The input/output device 640 provides input/output operations for the computing system 600. In some example embodiments, the input/output device 640 includes a keyboard and/or pointing device. In various implementations, the input/output device 640 includes a display unit for displaying graphical user interfaces.

Systems and methods described in this application can provide several advantages. For example, by automating the process of annotating assets in an image, the need for human involvement (which can be slow and error prone) can be reduced. For example, manually placing a handful of annotation points on a 3D model can automatically generates multiple 2D annotation regions with little or no human involvement. This gain would be proportional to the number of test site images. For example, if an object is annotated with 4 points in the 3D model and the four points are visible on say 100 images, 400 annotation points can be generated. Without the methods described in this application, an annotator would have to manually place 400 points. Moreover, this would require a human operator to sift through the 100 images and select the 400 annotations points (e.g., by 400 clicks). Through this application, an operator would only have to select four points (e.g., by 4 clicks) in the 3D model rather than 400 clicks in the 100 images.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A method comprising:
receiving data characterizing a two-dimensional target site image including an image of a first asset acquired by a camera, wherein the camera has a first location during the acquisition of the two-dimensional target site image;
receiving data characterizing a three-dimensional model of a target site that includes a plurality of assets including the first asset, wherein the three-dimensional model is annotated to at least identify the first asset; and
generating a projected annotation of the first asset on the two-dimensional target site image by at least projecting the three-dimensional model based on the first location and orientation of the camera relative to the first asset during the acquisition of the target site image.

2. The method of claim 1, further comprising:
receiving data characterizing a plurality of two-dimensional images of the target site acquired at a plurality of locations, wherein each image of the plurality of two-dimensional images is acquired at a unique location of the plurality of locations and with a unique camera orientation of the plurality of orientations;
generating the three-dimensional model of the target site based on the plurality of two-dimensional images;
receiving data characterizing the identity of one or more of the plurality of assets in the target site; and
annotating the three-dimensional model of the industrial asset to identify at least the first asset of the plurality assets.

3. The method of claim 2, further comprising:
providing, via a graphical user interface, the three-dimensional model of the target site to a user;
receiving user input indicative of data characterizing identity of a first asset of the plurality of assets in the target site; and
annotating at least a first portion of the three-dimensional model indicative of the first asset based on the received user input.

4. The method of claim 2, further comprising receiving data characterizing the plurality locations associated with the acquisition of the plurality of two-dimensional images.

5. The method of claim 4, wherein the plurality of locations are detected by one of a position sensor and a global positional system tag coupled to the camera or to a drone to which the camera is attached.

6. The method of claim 1, wherein the camera is coupled to one of a drone and a satellite configured to inspect the target site.

7. The method of claim 1, wherein the annotation of the first asset includes determining a first contour associated with the first asset.

8. The method of claim 7, wherein determining the first contour includes:
determining that a first distance between the first asset and the camera is greater than a second distance between a second asset and the camera, where in the first asset and the second asset are located adjacent to each other;
identifying a first portion of the first contour that overlaps with the second asset; and
annotating the first asset to preclude portions of the first asset located between the first portion of the first contour and a second contour of the second asset.

9. The method of claim 1, further comprising:
determining that a first distance between a first portion of the first asset and the camera is greater than a second distance between a second portion of a second asset and the camera;
identifying that the first portion of the first asset overlaps with the second portion of the second asset from the perspective of the camera during the acquisition of the two-dimensional target site image; and
annotating the first asset to preclude the first portion of the first asset.

10. A system comprising:
at least one data processor;
memory coupled to the at least one data processor, the memory storing instructions to cause the at least one data processor to perform operations comprising:
receiving data characterizing a two-dimensional target site image including an image of a first asset acquired by a camera, wherein the camera has a first location during the acquisition of the two-dimensional target site image;
receiving data characterizing a three-dimensional model of a target site that includes a plurality of assets including the first asset, wherein the three-dimensional model is annotated to at least identify the first asset; and
generating a projected annotation of the first asset on the two-dimensional target site image by at least projecting the three-dimensional model based on the first location and orientation of the camera relative to the first asset during the acquisition of the target site image.

11. The system of claim 10, wherein the operations further comprising:
receiving data characterizing a plurality of two-dimensional images of the target site acquired at a plurality of locations, wherein each image of the plurality of two-dimensional images is acquired at a unique location of the plurality of locations and with a unique camera orientation of the plurality of orientations;
generating the three-dimensional model of the target site based on the plurality of two-dimensional images;
receiving data characterizing the identity of one or more of the plurality of assets in the target site; and
annotating the three-dimensional model of the industrial asset to identify at least the first asset of the plurality assets.

12. The system of claim 11, wherein the operations further comprising:
providing, via a graphical user interface, the three-dimensional model of the target site to a user;
receiving user input indicative of data characterizing identity of a first asset of the plurality of assets in the target site; and
annotating at least a first portion of the three-dimensional model indicative of the first asset based on the received user input.

13. The system of claim 11, wherein the operations further comprising receiving data characterizing the plurality locations associated with the acquisition of the plurality of two-dimensional images.

14. The system of claim 13, wherein the plurality of locations are detected by one of a position sensor and a global positional system tag coupled to the camera or to a drone to which the camera is attached.

15. The system of claim 10, wherein the camera is coupled to one of a drone and a satellite configured to inspect the target site.

16. The system of claim 10, wherein the annotation of the first asset includes determining a first contour associated with the first asset.

17. The system of claim 16, wherein the operations further comprising:
determining that a first distance between the first asset and the camera is greater than a second distance between a second asset and the camera, where in the first asset and the second asset are located adjacent to each other;
identifying a first portion of the first contour that overlaps with the second asset; and
annotating the first asset to preclude portions of the first asset located between the first portion of the first contour and a second contour of the second asset.

18. The system of claim 10, wherein the operations further comprising
determining that a first distance between a first portion of the first asset and the camera is greater than a second distance between a second portion of a second asset and the camera;
identifying that the first portion of the first asset overlaps with the second portion of the second asset from the perspective of the camera during the acquisition of the two-dimensional target site image; and
annotating the first asset to preclude the first portion of the first asset.

19. A computer program product comprising a non-transitory machine-readable medium storing instructions that, when executed by at least one programmable processor that comprises at least one physical core and a plurality of logical cores, cause the at least one programmable processor to perform operations comprising:
receiving data characterizing a two-dimensional target site image including an image of a first asset acquired by a camera, wherein the camera has a first location during the acquisition of the two-dimensional target site image;
receiving data characterizing a three-dimensional model of a target site that includes a plurality of assets including the first asset, wherein the three-dimensional model is annotated to at least identify the first asset; and
generating a projected annotation of the first asset on the two-dimensional target site image by at least projecting the three-dimensional model based on the first location and orientation of the camera relative to the first asset during the acquisition of the target site image.
